(19) United States
(12) Patent Application Publication
(10) Pub. No.: US 2007/0030612 A1
(43) Pub. Date: Feb. 8, 2007

(54) Reduced rating output rectifier snubber for plasma cutting power supply

(75) Inventor: Girish R. Kamath, Lebanon, NH (US)

Correspondence Address: PROSKAUER ROSE LLP, ONE INTERNATIONAL PLACE 14TH FL, BOSTON, MA, 02110, US

(73) Assignee: Hypertherm, Inc., Hanover, NH (US)

(21) Appl. No.: 11/490,746

(22) Filed: Jul. 21, 2006

Related U.S. Application Data
(60) Provisional application No. 60/701,570, filed on Jul. 23, 2005.

(51) Int. Cl. H02H 3/00

(52) U.S. Cl. 361/82

(57) ABSTRACT

A snubber circuit for absorbing reverse recovery current in a power supply is featured comprising a dissipative snubber circuit and a non-dissipative snubber circuit coupled in parallel to a source of reverse recovery current and a load. The dissipative snubber circuit is capable of dissipating a first amount of reverse recovery current from the reverse recovery current source and the non-dissipative snubber circuit recovering a second amount of reverse recovery current from the reverse recovery current source, resulting in the reverse recovery current being absorbed with reduced power dissipation.

### RELATED APPLICATIONS

This application claims the benefit of U.S. Provisional Application No. 60/701,570, filed on Jul. 23, 2005. The entire teachings of the above application(s) are incorporated herein by reference.

### BACKGROUND

R-C snubber circuits are used to absorb the energy associated with a reverse recovery current of a rectifier diode and limit the associated voltage spike across it. FIG. 1 is a schematic circuit diagram illustrating a conventional R-C snubber circuit as applied to a two-switch forward converter power supply. At the beginning of the energy delivery period, transistors Q1 and Q2 are initially turned on causing a load current Iₒ to flow through forward diode D9 and the freewheeling diode D10 to turn off. As the freewheeling diode D10 turns off, a reverse recovery current Iᵣᵣ conducts through diode D10, resulting in associated energy building up in the leakage inductance of the transformer secondary.

After the freewheeling diode D10 turns off, the current flowing through the forward diode D9 includes the load current Iₒ and the reverse recovery current Iᵣᵣ. The current source Iₒ illustrates that the current drawn by the load Rload is constant at Iₒ. An alternate path through an R-C snubber circuit is provided to dissipate the energy in the leakage inductance Llk due to Iᵣᵣ. The R-C snubber circuit is shown having a snubber resistor Rsnub and a snubber capacitor Csnub. Reverse recovery current Iᵣᵣ varies as a function of temperature and typically ranges between 50-150% of load current Iₒ.

### SUMMARY OF THE INVENTION

For applications with power levels above 10 kW and with switching frequencies above 15 kHz, the snubber resistor becomes bulky and expensive due to its high power dissipation. For example, in the Hyperthem PMX1650 plasma arc torch, a rectifier R-C snubber is utilized in a 100 A, 150V plasma cutting half-bridge converter power supply operating at 15 kHz switching frequency, dissipating 180 W in the snubber resistor. This amounts to about 7% of the total semiconductor power loss, thus influencing the cooling system design and cost.

According to one aspect, a snubber circuit is featured for absorbing reverse recovery current in a power supply. The snubber circuit includes a dissipative snubber circuit and a non-dissipative snubber circuit coupled in parallel to a source of reverse recovery current and a load. The dissipative snubber circuit dissipates a first amount of reverse recovery current from the reverse recovery current source, and the non-dissipative snubber circuit recovers a second amount of reverse recovery current from the reverse recovery current source, resulting in the reverse recovery current being absorbed with reduced power dissipation.

In particular embodiments of the snubber circuit, the dissipative snubber circuit can include a snubber resister coupled in series to a snubber capacitor, the snubber resister having a resistance value sufficient to dissipate the first amount of reverse recovery current from the reverse recovery current source, the first amount of reverse recovery current being less than the total amount of reverse recovery current. The snubber resistor can have a power rating for dissipating the first amount of reverse recovery current that is less than a power rating sufficient for dissipating the total amount of reverse recovery current.

In particular embodiments, of the snubber circuit, the non-dissipative snubber circuit comprises a resonant circuit including a resonant inductor and a resonant capacitor having a capacitance sufficient to limit a voltage spike across the reverse recovery current source. The non-dissipative snubber circuit can further comprise a zenor diode coupled in parallel across the resonant capacitor to further limit the voltage spike across the reverse recovery current source. The non-dissipative snubber circuit can further comprise a winding being coupled in parallel to the load, the winding being magnetically coupled to the resonant inductor, resulting in variations in the voltage spike being reduced in response to changes in an output voltage across the load.

In particular embodiments, the source of reverse recovery current comprises a diode rectifier circuit coupled in parallel between a transformer and the load, the transformer storing reverse recovery current from the diode rectifier circuit. The diode rectifier circuit can further comprise a forward diode and a freewheeling diode, the forward diode being coupled in series to the transformer, the freewheeling diode being coupled in parallel to the series-coupled transformer and forward diode. The non-dissipative snubber circuit can comprise a resonant circuit, the resonant circuit including a resonant inductor and a resonant capacitor, the resonant capacitor having a capacitance sufficient to limit a voltage spike across the freewheeling diode.

In particular embodiments, the power supply can be a power supply for a high temperature metal processing torch.

According to another aspect, a method is featured for absorbing reverse recovery current in a power supply, the power supply comprising a dissipative snubber circuit and a non-dissipative snubber circuit coupled in parallel to a source of reverse recovery current and a load. According to particular embodiments, the method comprises the steps of dissipating a first amount of reverse recovery current from the reverse recovery current source through the dissipative snubber circuit; and recovering a second amount of reverse recovery current from the reverse recovery current source through the non-dissipative snubber circuit, resulting in the reverse recovery current being absorbed with reduced power dissipation.

Where the dissipative snubber circuit comprises a snubber resister coupled in series to a snubber capacitor, the method can further comprise the step of dissipating the first amount of reverse recovery current from the reverse recovery current source through the snubber resister, the snubber resister having a resistance value sufficient to dissipate an amount of reverse recovery current which is less than the total amount of reverse recovery current.

Where the dissipative snubber circuit comprises a snubber resister coupled in series to a snubber capacitor, the method can further comprise the step of dissipating the first amount of reverse recovery current from the reverse recovery current source through the snubber resister, the snubber resister having a power rating for dissipating an amount of reverse recovery current which is less than a power rating sufficient for dissipating the total amount of reverse recovery current.

Where the non-dissipative snubber circuit comprises a resonant circuit that includes a resonant inductor and a resonant capacitor, the method can further comprise the step of recovering the second amount of reverse recovery current from the reverse recovery current source through the non-dissipative snubber circuit, the resonant capacitor having a capacitance sufficient to limit a voltage spike across the reverse recovery current source.

In particular embodiments, the source of reverse recovery current can include a diode rectifier circuit coupled in parallel between a transformer and the load, the transformer storing reverse recovery current from the diode rectifier circuit.

Where the non-dissipative snubber circuit comprises a resonant circuit that includes a resonant inductor and a resonant capacitor, the method can further comprise the step of recovering the second amount of reverse recovery current from the transformer through the non-dissipative snubber circuit, the resonant capacitor having a capacitance sufficient to limit a voltage spike across the diode rectifier circuit.

In particular embodiments, the non-dissipative snubber circuit can further comprise a zenor diode coupled in parallel across the resonant capacitor to further limit the voltage spike across the reverse recovery current source.

In particular embodiments, the non-dissipative snubber circuit can further comprise a winding coupled in parallel to the load, the winding being magnetically coupled to the resonant inductor, resulting in variations in the voltage spike being reduced in response to changes in an output voltage across the load.

According to another aspect, a method is featured for manufacturing a snubber circuit that absorbs reverse recovery current in a power supply. In particular embodiments, the method can include the steps of coupling a dissipative snubber circuit and a non-dissipative snubber circuit in parallel to a source of reverse recovery current and a load, wherein the dissipative snubber circuit is capable of dissipating a first amount of reverse recovery current from the reverse recovery current source through the dissipative snubber circuit and the non-dissipative snubber circuit is capable of recovering a second amount of reverse recovery current from the reverse recovery current source through the non-dissipative snubber circuit, resulting in the reverse recovery current being absorbed with reduced power dissipation.

In particular embodiments, the method can further comprise the step of providing the dissipative snubber circuit comprising a snubber resister coupled in series to a snubber capacitor, the snubber resister having a resistance value sufficient to dissipate an amount of reverse recovery current from the reverse recovery current source which is less than the total amount of reverse recovery current.

In particular embodiments, the method can further comprise the step of providing the dissipative snubber circuit comprising a snubber resister coupled in series to a snubber capacitor, the snubber resistor having a power rating for dissipating an amount of reverse recovery current which is less than a power rating sufficient for dissipating the total amount of reverse recovery current.

In particular embodiments, the method can further comprise the step of providing the non-dissipative snubber circuit comprising a resonant circuit, the resonant circuit including a resonant inductor and a resonant capacitor, the resonant capacitor having a capacitance sufficient to limit a voltage spike across the reverse recovery current source.

In particular embodiments, the source of reverse recovery current can comprise a diode rectifier circuit coupled in parallel between a transformer and the load, the transformer storing reverse recovery current from the diode rectifier circuit. In such embodiments, the method can further comprise the step of providing the non-dissipative snubber circuit comprising a resonant circuit, the resonant circuit including a resonant inductor and a resonant capacitor, the resonant capacitor having a capacitance sufficient to limit a voltage spike across the diode rectifier circuit.

In particular embodiments, the method can further comprise the step of providing the diode rectifier circuit comprising a forward diode and a freewheeling diode, the forward diode being coupled in series to the transformer, the freewheeling diode being coupled in parallel to the series-coupled transformer and forward diode; and providing the non-dissipative snubber circuit comprising a resonant circuit, the resonant circuit including a inductor, the resonant circuit further including a capacitor having a capacitance sufficient to limit a voltage spike across the freewheeling diode.

In particular embodiments, the method can further comprise the step of coupling a zenor diode in parallel across the resonant capacitor to further limit the voltage spike across the reverse recovery current source.

In particular embodiments, the method can further comprise the step of coupling a winding in parallel to the load, the winding being magnetically coupled to the resonant inductor, resulting in variations in the voltage spike being reduced in response to changes in an output voltage across the load.

According to another aspect, a snubber circuit is featured for absorbing reverse recovery current in a power supply, the snubber circuit including a passive circuit for dissipating a first amount of reverse recovery current from the reverse recovery current source. The snubber circuit further comprises a non-dissipative snubber circuit coupled in parallel to a source of reverse recovery current and a load, the non-dissipative snubber circuit recovering a second amount of reverse recovery current from the reverse recovery current source, resulting in the reverse recovery current being absorbed with reduced power dissipation. The non-dissipative snubber circuit can include a resonant circuit that recovers the second amount of reverse recovery current and maintains the voltage stress across a diode rectifier circuit within a rated range of the diode rectifier circuit.

According to another aspect, a method is featured for manufacturing a snubber circuit for absorbing reverse recovery current in a power supply, the snubber circuit comprising a dissipative snubber circuit coupled in parallel to a source of reverse recovery current and a load, the dissipative snubber circuit dissipating a first amount of reverse recovery current from the reverse recovery current source. The method can include the steps of coupling to the snubber circuit a non-dissipative snubber circuit in parallel to the source of reverse recovery current and the load, the non-dissipative snubber circuit recovering a second amount of reverse recovery current from the reverse recovery current source, resulting in the reverse recovery current being absorbed with reduced power dissipation. The non-dissipative snubber circuit can include a resonant circuit that recovers the second amount of reverse recovery current and maintains the voltage stress across a diode rectifier circuit within a rated range of the diode rectifier circuit.

According to another aspect, a power supply is featured that comprises a power source coupled to a transformer; a diode rectifier circuit coupled in parallel between the transformer and a load, the transformer storing reverse recovery current from the diode rectifier circuit; a snubber circuit for absorbing reverse recovery current in the power supply, the snubber circuit comprising a dissipative snubber circuit and a non-dissipative snubber circuit coupled in parallel to the transformer and the load; the dissipative snubber circuit dissipating a first amount of reverse recovery current; and the non-dissipative snubber circuit recovering a second amount of reverse recovery current, resulting in the reverse recovery current being absorbed with reduced power dissipation. The non-dissipative snubber circuit can include a resonant circuit that recovers the second amount of reverse recovery current and maintains the voltage stress across the diode rectifier circuit within a rated range of the diode rectifier circuit.

According to another aspect, a snubber circuit is featured for absorbing reverse recovery current in a power supply, the snubber circuit including means for dissipating a first amount of reverse recovery current from a source of reverse recovery current in a power supply; and means for recovering a second amount of reverse recovery current in the power supply, resulting in the reverse recovery current being absorbed with reduced power dissipation. The means for recovering a second amount of reverse recovery current can maintain the voltage stress across a diode rectifier circuit within a rated range of the diode rectifier circuit.

Particular embodiments of the invention feature a reduced rating snubber that can keep the snubber power dissipation to a minimum and can also limit the rectifier voltage stress to reasonable levels over the entire power supply operating range. For example, in one such embodiment, the power dissipation can be reduced by 60% to 70% when compared with the conventional R-C snubber methods.

It can achieve these objectives by using the conventional R-C snubber across the output diode and reducing the snubber resistor power dissipation by means of a non-dissipative auxiliary circuit. This circuit can divert a portion of the reverse recovery current and recycles it efficiently back to the load. Since the auxiliary circuit preferably uses only passive components, the overall reliability of the circuit is still maintained.

### BRIEF DESCRIPTIONS OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic circuit diagram illustrating a conventional R-C snubber circuit as applied to a two-switch forward converter power supply.

FIG. 2 is a schematic circuit diagram of a two-switch forward converter power supply including a snubber circuit according to a first embodiment.

FIG. 3A is a schematic circuit diagram that illustrates circuit operation immediately after the reverse recovery period.

FIG. 3B is a schematic circuit diagram that illustrates circuit operation during a resonant phase of the energy delivery period.

FIG. 3C is a schematic circuit diagram that illustrates circuit operation during the freewheeling period.

FIG. 4 is a diagram that illustrates a simplified circuit model of a two-switch forward converter utilizing the snubber circuit of FIG. 2.

FIGS. 5A through 5C are diagrams that show the signal waveforms obtained from simulating a power supply circuit utilizing the snubber circuit modeled in FIG. 4.

FIG. 6 is a diagram that shows the signal waveforms obtained from simulating a power supply circuit utilizing a conventional R-C snubber.

FIG. 7 is a circuit diagram that illustrates a 3-Φ 208V/60 Hz, 7 kW four-switch forward power converter.

FIG. 8A is a diagram that shows the signal waveforms observed during operation of the power supply of FIG. 7 utilizing the snubber circuit according to the first embodiment.

FIG. 8B is a diagram that shows the signal waveforms observed during operation of the power supply of FIG. 7 retrofitted with a conventional R-C snubber.

FIG. 9 is a circuit diagram that illustrates a power supply unit of a Hypertherm PMX 1650 (100 A, 150 V output) plasma arc torch retrofitted to include the snubber circuit of FIG. 2.

FIG. 10A is a diagram that shows the signal waveforms observed during operation of the power supply unit of FIG. 9.

FIG. 10B is a diagram that shows the signal waveforms observed during operation of the power supply of FIG. 9 retrofitted with a conventional R-C snubber circuit.

FIGS. 10C and 10D are diagrams that show the signal waveforms observed during operation of the power supply unit of FIG. 9 with output voltage Vo at 150 V and 230 V respectively.

FIG. 10E displays variations in the normalized rectifier voltage with the power supply normalized output voltage due to the new and conventional snubber circuits at rated load.

FIG. 11 is a schematic circuit diagram of a two-switch forward converter power supply including a snubber circuit according to a second embodiment.

FIG. 12 is a schematic circuit diagram of a two-switch forward converter power supply including a snubber circuit according to a third embodiment.

### DETAILED DESCRIPTION

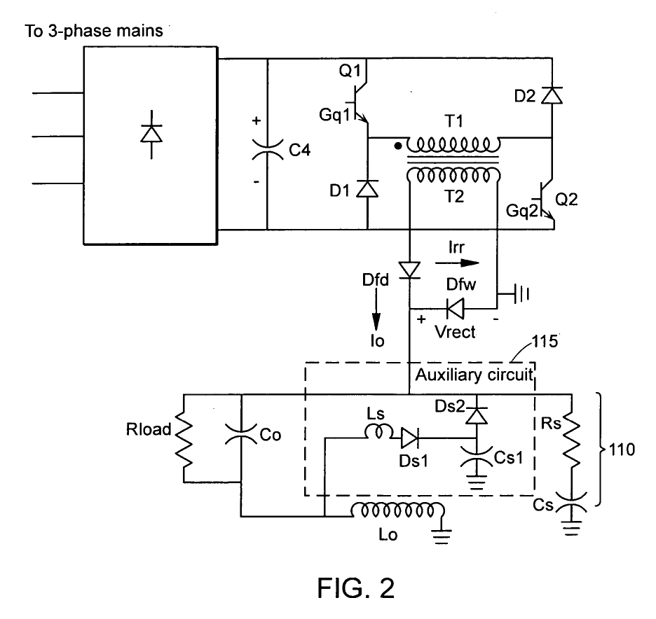

FIG. 2 is a schematic circuit diagram of a two-switch forward converter power supply including a snubber circuit according to a first embodiment. The snubber circuit can be implemented in power supply units of any number of applications, including high temperature metal processing such as plasma cutting, welding and laser processing. As shown, the snubber circuit includes a dissipative snubber circuit 110 and a non-dissipative auxiliary snubber circuit 115. The dissipative snubber circuit 110 can be a conventional R-C snubber circuit that includes a resister Rₛ in series with a capacitor Cₛ connected across the free-wheeling diode D_{fw}. The non-dissipative snubber circuit 115 is an auxiliary circuit that can include an inductor Lₛ, capacitor Cₛ₁ and diodes Dₛ₁, Dₛ₂.

Snubber Circuit Operation During Energy Delivery Period

Referring to FIG. 2, the energy (or forward power) delivery period begins with the initiation of a reverse recovery period. At the beginning of the reverse recovery period, switches Q1 and Q2 are turned on causing a load current Iₒ to flow through forward diode D_{fd} and the freewheeling diode D_{fw} to turn off. As the freewheeling diode D_{fw} turns off, a reverse recovery current Iᵣᵣ conducts through the freewheeling diode D_{fw}, resulting in associated energy building up within the leakage inductance Lₗₖ (not shown) of the transformer secondary T2. The reverse recovery period ends after the freewheeling diode D_{fw} turns off, resulting in the current flowing through the forward diode D_{fd} including both the load current Iₒ and the reverse recovery current Iᵣᵣ.

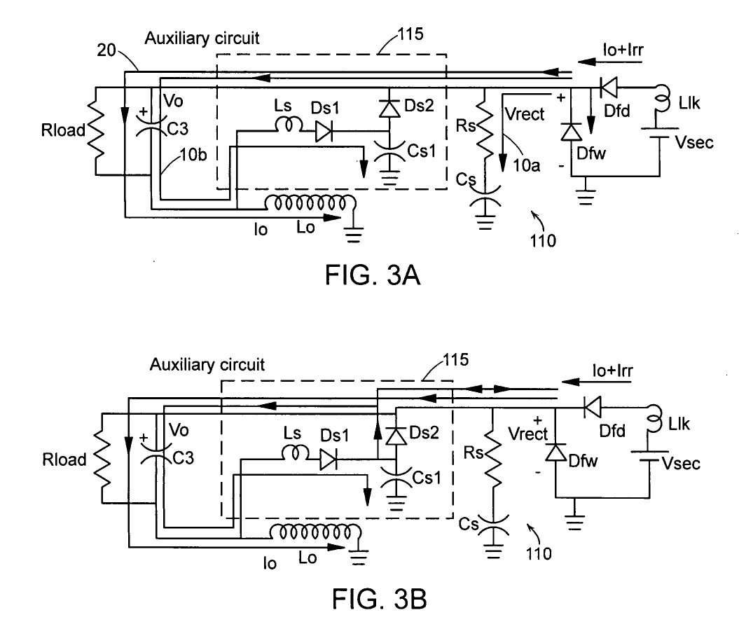

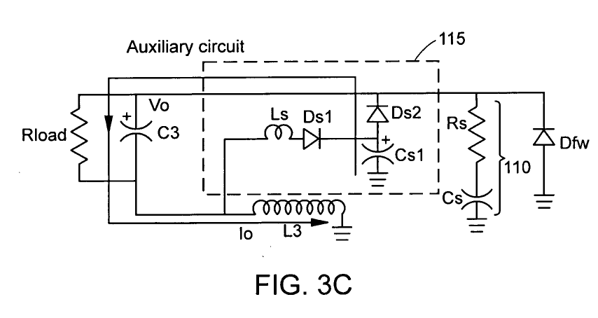

FIG. 3A is a schematic circuit diagram that illustrates circuit operation immediately after the reverse recovery period. As shown, the transformer secondary is represented by a dc-voltage source V_{sec} due to the reflected primary winding voltage and leakage inductance Lₗₖ. Paths 10a and 10b indicate the flow of reverse recovery current Iᵣᵣ through the dissipative snubber circuit 110 and the non-dissipative auxiliary snubber circuit 115, respectively. Path 20 indicates the flow of output current Iₒ from the input into the load Rload, such as a plasma arc load.

The diode reverse recovery current Iᵣᵣ is drawn from the leakage inductance Lₗₖ of the transformer secondary by the non-dissipative auxiliary snubber circuit 115 and the dissipative snubber circuit 110. The dissipative snubber circuit 110 power dissipates a portion of the energy associated with the reverse recovery current Iᵣᵣ according to the resistance of snubber resistor Rs. This portion is less than the total amount of energy built up in the leakage inductance Llk. The non-dissipative auxiliary snubber circuit 115 recovers and recycles the remainder of the Lₗₖ energy. In order to minimize the power dissipation from the snubber resistor Rs, the inductance value of inductor Lₛ can be reduced resulting in a larger portion of the reverse recovery current Iᵣᵣ being diverted through the auxiliary snubber circuit 115. In one particular embodiment, about 40% of the Llk energy associated with Irr is power dissipated and about 60% of the Llk energy is recovered and recycled to the load.

As shown in FIG. 3A, the dissipative snubber circuit 110 comprises a snubber resister Rs coupled in series to a snubber capacitor Cs. The snubber resister Rs has a resistance value sufficient to dissipate a portion of the reverse recovery current. Because the amount of reverse recovery current Iᵣᵣ being dissipated by the R-C snubber circuit is less than the total amount of reverse recovery current Iᵣᵣ, the snubber resistor can have a significantly lower power rating, enabling the use of less expensive and compact snubber resistors and reduced costs.

Also shown in FIG. 3A, the non-dissipative auxiliary circuit 115 comprises a resonant circuit including a snubber inductor Lₛ and a snubber capacitor Cₛ₁ having a capacitance sufficient to limit a voltage spike (or overshoot) Vrect across the freewheeling diode D_{fw}. Specifically, the remainder of the reverse recovery current Iᵣᵣ is drawn into the snubber inductor Lₛ, which is then stored in the snubber capacitor Cₛ₁ for recycling to the load Rload. The current build up in the auxiliary circuit 115 is determined mainly by the inductance of snubber inductor Lₛ. The output rectifier voltage stress Vrect (e.g., spike or overshoot) that is applied across the freewheeling diode D_{fw} at the end of the reverse recovery period can be minimized by increasing the current build up in the inductor Lₛ. After the freewheeling diode D_{fw} has completely turned off, a resonant phase of the energy delivery period begins.

FIG. 3B is a schematic circuit diagram that illustrates circuit operation during a resonant phase of the energy delivery period. During the resonant period, a resonant mechanism is utilized for transferring energy from the leakage inductance Lₗₖ to the non-dissipative auxiliary circuit 115. The transfer is complete when the reverse recovery current Iᵣᵣ in leakage inductance Lₗₖ diminishes to zero. Specifically, after the freewheeling diode D_{fw} has completely turned off, the snubber capacitor Cₛ₁ of the auxiliary circuit 115 recovers the energy stored in the inductor Lₛ by forming a resonant circuit with diodes Dₛ₁, Dₛ₂, transformer secondary voltage V_{sec} and leakage inductance Lₗₖ. The resulting voltage across capacitor Cₛ₁ is proportional to the current build-up in the inductor Lₛ at the beginning of the resonant period Vsec and the output voltage Vₒ. The load Rload continues to draw current I₀, while the resonant operation of the non-dissipative auxiliary circuit 115 draws the reverse recovery current Iᵣᵣ until the current diminishes to zero. The current flow through the Rₛ-Cₛ branch is negligible due to its high impedance and can be ignored.

The power dissipation in the snubber resistor Rs can be minimized by reducing inductance value of inductor Lₛ since it can diverts a larger portion of the reverse recovery current Iᵣᵣ. However, the peak output rectifier voltage stress (vrect(pk)) is now determined by the voltage across capacitor Cₛ₁ during the resonant period. Reducing the rectifier voltage (vrect(pk)) during the resonant period requires a higher value of Lₛ. Thus, the inductor Lₛ and the capacitor Cₛ₁ are optimally selected to keep the diode voltage stress at reasonable levels over the entire load operating range while keeping the associated snubber power dissipation to a minimum.

Snubber Circuit Operation During the Freewheeling Period:

FIG. 3C is a schematic circuit diagram that illustrates circuit operation during the freewheeling period. During the free-wheeling period, switches Q1 and Q2 are turned off causing the forward diode D_{fd} to become reversed biased. After the forward diode D_{fd} is reverse biased and stops conducting current, the energy stored in the capacitor Cₛ₁ is returned to the load efficiently through the path 30. With the capacitor Cₛ₁ completely discharged, the free-wheeling diode D_{fw} becomes forward biased and conducts the load current Iₒ for the rest of the period. The non-dissipative auxiliary circuit 115 remains inactive during this time.

Simulation Investigation and Results

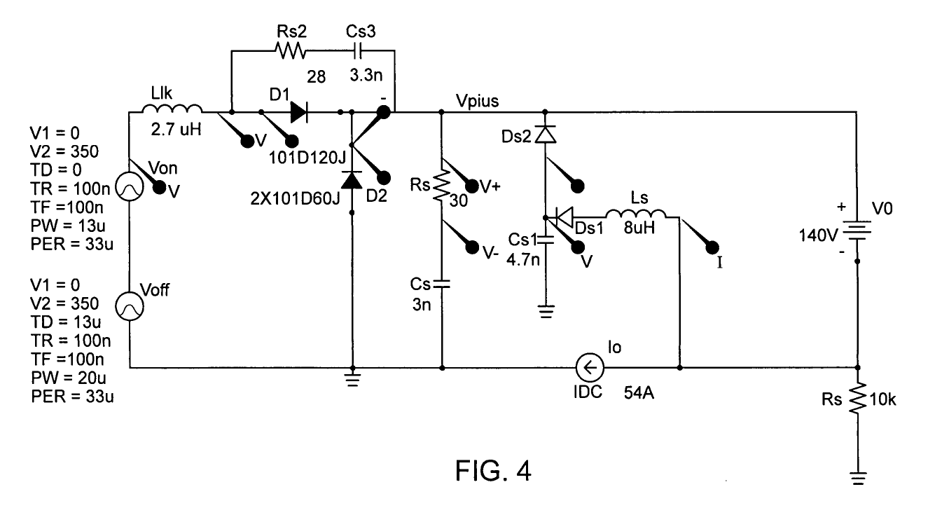

FIG. 4 is a diagram that illustrates a simplified circuit model of a two-switch forward converter utilizing the snubber circuit of FIG. 2. The snubber circuit is simulated in ORCAD-PSPICE to evaluate its performance under different operating conditions. The various snubber and diode components values used in the circuit are indicated in the FIG. 4. In this model, the snubber circuit components are selected to minimize the output rectifier voltage stress (i.e., the voltage v_{rect} across the freewheeling diode D2) under nominal load conditions (e.g., 140 V and 54 A output).

The circuit model is derived based on the following assumptions:

(1) The circuit is operating under steady state conditions.

(2) The snubber diodes Ds1, Ds2 are ideal, i.e. these have zero conduction voltage drops and transient switching times.

(3) Output voltage Vo does not change during the entire switching period and is hence represented as a constant dc voltage source.

(4) The inductor current is constant and has no ripple. Hence it is represented as a constant current source Io.

(5) The reflected high frequency PWM ac voltage appearing across the transformer secondary is represented as a series connection of pulse voltage sources, Von and Voff, during the converter on and off periods respectively. This PWM ac voltage has an amplitude Vi of 350 V and a switching frequency of 33 kHz. The value Llk is the total transformer leakage inductance reflected to the secondary. It is noted that the voltage source does not faithfully represent the open circuit mode of the transformer secondary. This mode occurs after the transformer primary flux is reset during the free-wheeling period. However, this does not in any way influence the circuit performance, especially in terms of monitoring the transient and steady state output rectifier voltage vrect during the energy (forward power) delivery period.

The main power diodes D1, D2 are 100 A, 1200 V (APT2X100D120J) and 100 A, 600 V (APT2X100D60J) Ultra-soft fast recovery diodes respectively. The appropriate SPICE diode circuit models used in the simulation are available at the manufacturer's website (Advanced Power Technology, Inc. Ultra-fast soft recovery diodes APT2X100D120J and APT2X100D60J. Available: http://www.advancedpower.com/DTDisplay/Default.aspxpart?Number=APT2X101).

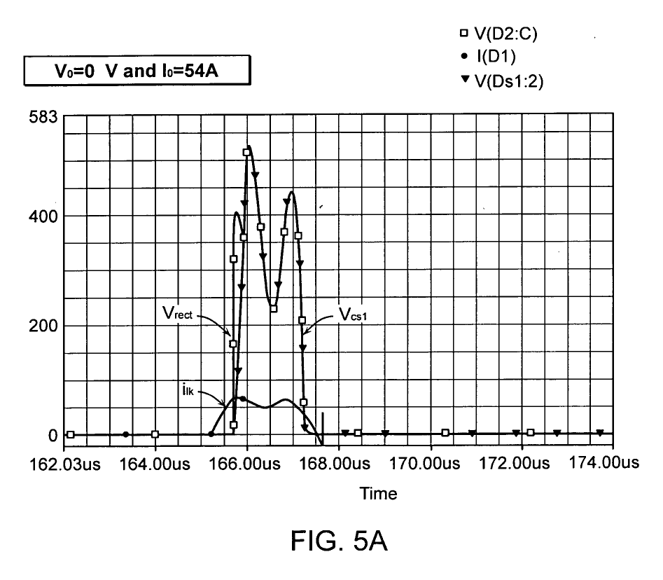

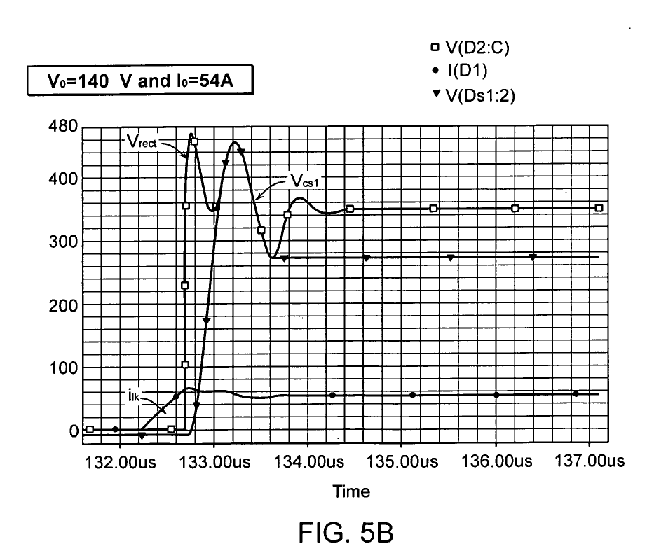

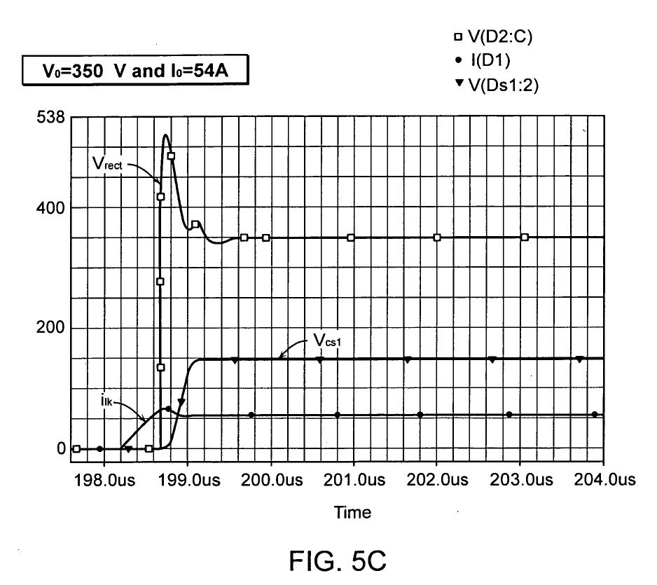

FIGS. 5A through 5C are diagrams that show the signal waveforms obtained from simulating a power supply circuit utilizing the snubber circuit modeled in FIG. 4. Specifically, FIGS. 5A, 5B and 5C show the signal waveforms during circuit operation where the output voltage is a short circuit (0 V), a nominal arc voltage (e.g., 140 V), and a stretch arc voltage (e.g., 350 V), respectively. In each simulation, the load current Io is fixed at 54 A and the simulated waveforms correspond to the output rectifier voltage stress (v_{rect}), the voltage across the snubber capacitor Cs1 of the auxiliary circuit (v_{cs1}) and the leakage current (iₗₖ). The results are summarized in Table 1.

TABLE 1

| Vo (V) | Vi (V) | vrect (pk) − V | Rs power (W) | vrect (pk)/Vi |
|---|---|---|---|---|
| 0 | 350 | 521 | 13.6 | 1.49 |
| 150 | 350 | 470 | 12.4 | 1.34 |
| 350 | 350 | 518 | 13 | 1.48 |

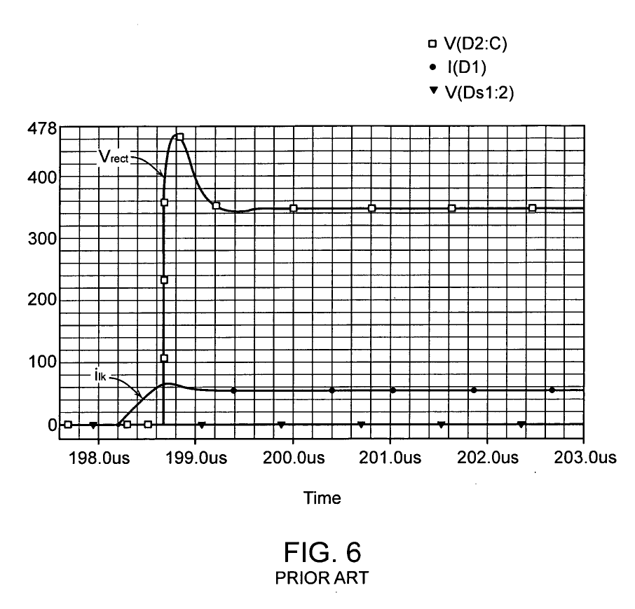

For purposes of comparison, FIG. 6 is a diagram that shows the signal waveforms obtained from simulating a power supply circuit utilizing a conventional R-C snubber. Specifically, the R-C snubber circuit is modeled using values Rs=30Ω and Cs=6.2 nf. The simulated waveforms of R-C snubber circuit include the output rectifier voltage stress (vrect) and leakage current (iₗₖ). As shown in FIG. 6, the results include a peak output rectifier voltage stress (vrect(pk)) of 470 V that is independent of the duty cycle of operation. As a result, a power loss of 28 W is incurred in the snubber resister Rs.

Thus, the simulated results show a reduction of 50% in the snubber power dissipation using snubber circuit of FIG. 2 for the same peak rectifier voltage stress (i.e. 12.4 W). Although there may be an increase in vrect (pk) at low and high values of the output voltage Vo using the snubber circuit of FIG. 2, the peak voltage across the freewheeling diode (vrect (pk)) is still well within the peak diode voltage rating enabling use of 600 V diodes for this application.

Experimental Results and Discussion

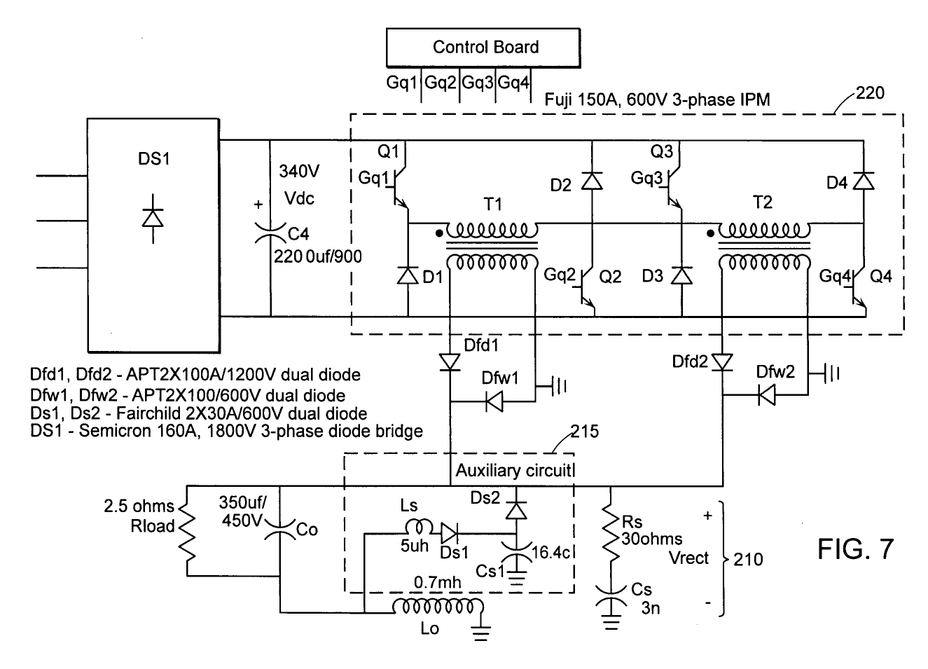

FIG. 7 is a circuit diagram that illustrates a 3-Φ 208V/60 Hz, 7 kW four-switch forward power converter. Switches Q1-Q4 and transformer flux resetting diodes D1-D4 can be realized using a 100 A, 600V six-switch IPM (Intelligent Power Module—Fuji 6 MBP 100RTB060). For the sake of clarity, the unused switches in the IPM are not shown in the diagram. As shown, the power supply circuit includes a dissipative snubber circuit 210, a non-dissipative auxiliary circuit 215 and the 100 A, 600V six-switch IPM 220. The details of the magnetic and snubber component values are identified in the FIG. 7 and in Table 2 below.

TABLE 2

| Components | Description | Semiconductor Device |
|---|---|---|
| Lₛ | Auxiliary inductor | 5uh/15 A(pk)/5Arms |
| Cₛ₁ | Auxiliary Capacitor | 16.4n/1600 V |
| T1, T2 | Main forward | Secondary/Primary turns ratio - |
| | transformers | 1.08:1, Primary current - |
| | | 40 A rms, Secondary current - |
| | | 36 A rms |
| Lo | Output filter inductor | 700uh/65 A powder iron core |
| | | inductor |
| Rₛ | Snubber resistor | 30 ohms/50 W |
| Cₛ | Snubber capacitor | 3 nf/1600 V |

The control board generates gate signals (G_{q1}-G_{q4}) for the forward switches Q₁-Q₄ with Q₁-Q₂ and Q₃-Q₄ being switched simultaneously in pairs. Switches Q₁-Q₂ and Q₃-Q₄ operate out of phase by 180° with a switching frequency of 15 kHz and duty cycle limited to 45%. These signals are fed through opto-isolators (HCPL 5406) to their respective IPM switch control terminals.

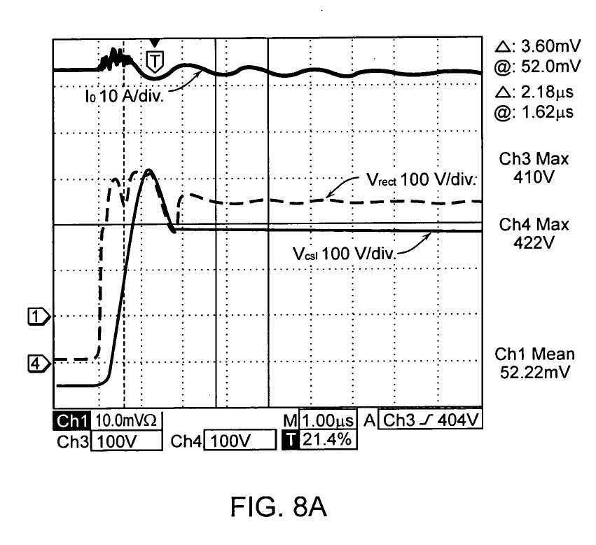

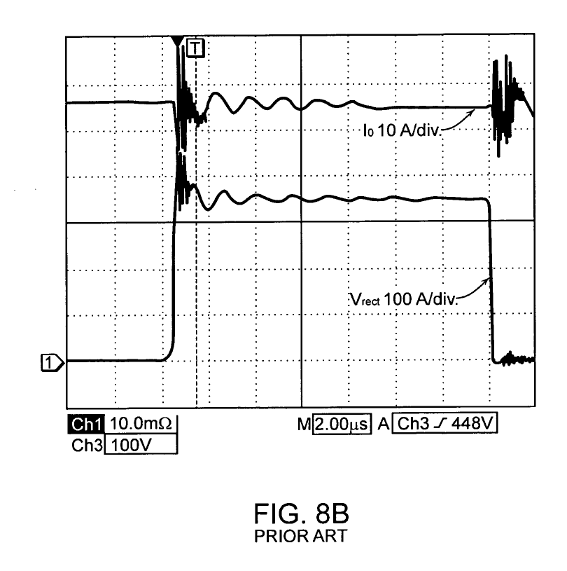

FIG. 8A is a diagram that shows the signal waveforms observed during operation of the power supply of FIG. 7 utilizing the snubber circuit according to the first embodiment. The graph is generated under the following conditions:

1) Mains 3-Φ input Vᵢₙ=240V, 60 Hz. The transformer secondary voltage V_{sec} has an amplitude of 352 V at no load.

2) The cumulative duty cycle is adjusted to 40%, i.e. 20% for each switch pair. This results in Vₒ=138V, Iₒ=54 A with R_{load}=2.5 ohm.

Specifically, FIG. 8A shows the output rectifier voltage stress (v_{rect}), the output current Iₒ and the voltage across the auxiliary snubber capacitor Cₛ₁ (V_{cs1}) during the energy delivery period. By utilizing the snubber circuit of FIG. 7, a peak output rectifier voltage stress V_{rect}(pk) is observed at 418 V, while the power dissipated in Rₛ is about 16 W.

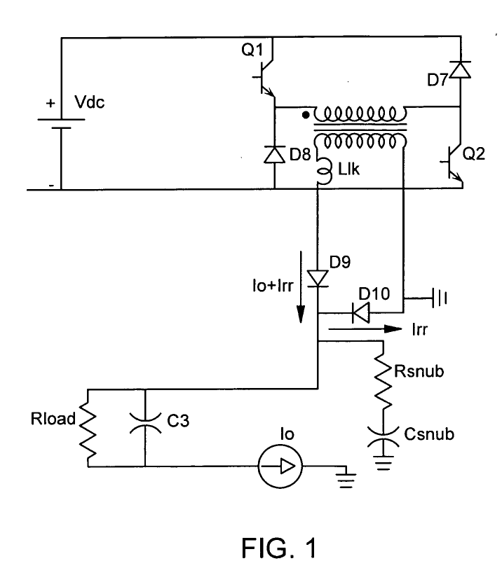

In contrast, a comparative evaluation of the conventional R-C snubber circuit of FIG. 1 can be conducted by disconnecting the auxiliary circuit and performing measurements under the same test conditions with the following R-C snubber values: Rₛ=30 ohms/50 W and Cs=8.2 nf/1600V. FIG. 8B is a diagram that shows the signal waveforms observed during operation of the power supply of FIG. 7 retrofitted with a conventional R-C snubber. As shown in FIG. 8B, a peak output rectifier voltage stress V_{rect}(pk) value is observed to increase to 452V under these conditions while the snubber power dissipation is 43 W. Thus the snubber circuit of FIG. 7 achieves a significant reduction of about 60% in the snubber power dissipation even as the peak overshoot of output diode voltage v_{rect} is reduced by about 30% when compared to the conventional R-C snubber circuit under the same test conditions.

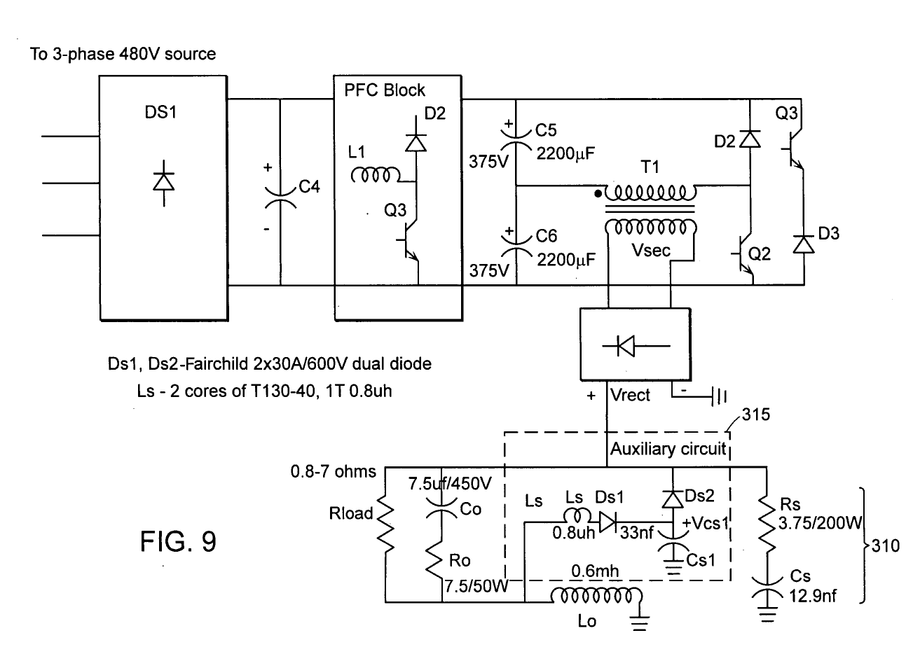

FIG. 9 is a circuit diagram that illustrates a power supply unit of a Hypertherm PMX 1650 (100 A, 150 V output) plasma arc torch retrofitted to include the snubber circuit of FIG. 2. As shown, the snubber circuit includes a dissipative snubber circuit 310 and a non-dissipative snubber circuit 315. The details of the magnetic and snubber component values are identified in FIG. 9 and in Table 3 below.

TABLE 3

| Components | Description | Semiconductor Device |
|---|---|---|
| Lₛ | Auxiliary inductor | 800 nh/25 A (pk)/3 A rms |
| Cₛ₁ | Auxiliary Capacitor | 33 nf/1600 V |
| T1 | Main forward | Winding turns ratio - 0.8:1 |
| | transformers | |
| Lₒ | Output filter inductor | 600 μh/100 A powder |
| | | iron core inductor |
| Rₛ | Snubber resistor | 3.75 ohms/200 W |
| Cₛ | Snubber capacitor | 12.9 nf/1600 V |

These selected values are optimized to minimize peak output rectifier voltage stress (vrect(pk)) under the following load conditions:

(1) Mains 3-Φ input 480 V, 60 Hz. This produces a no load transformer secondary voltage with amplitude Vsec of 290 V.

(2) Io is adjusted to 100 A with Rload—1.8Ω. This results in Vo—180 V, which is a typical arc load voltage.

It is noted that the power supply circuitry of the Hypertherm PMX1650 plasma arc torch does not have an output capacitor. Thus, for the purpose of experiment only, an additional Ro-Co series network is connected directly across the load. This series network provides a low impedance path for the snubber current i_{Ls} and enables proper snubber operation.

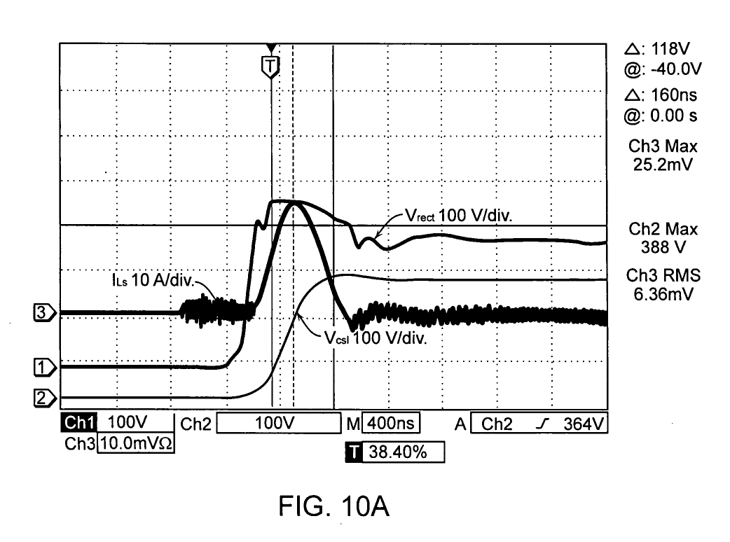

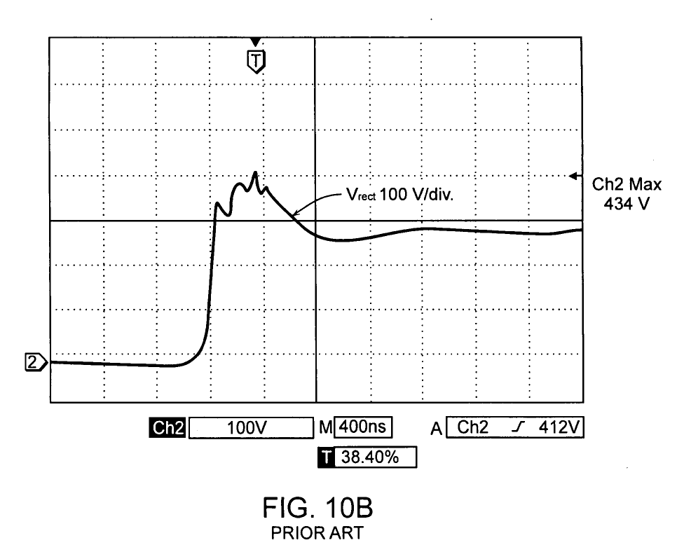

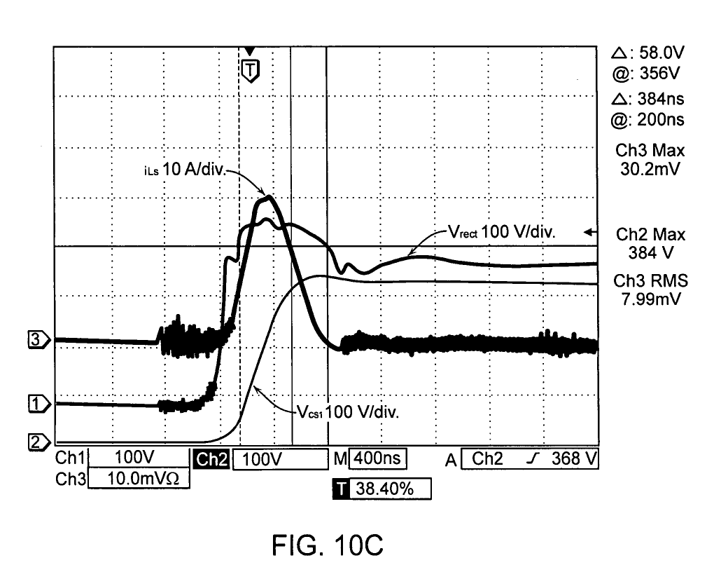

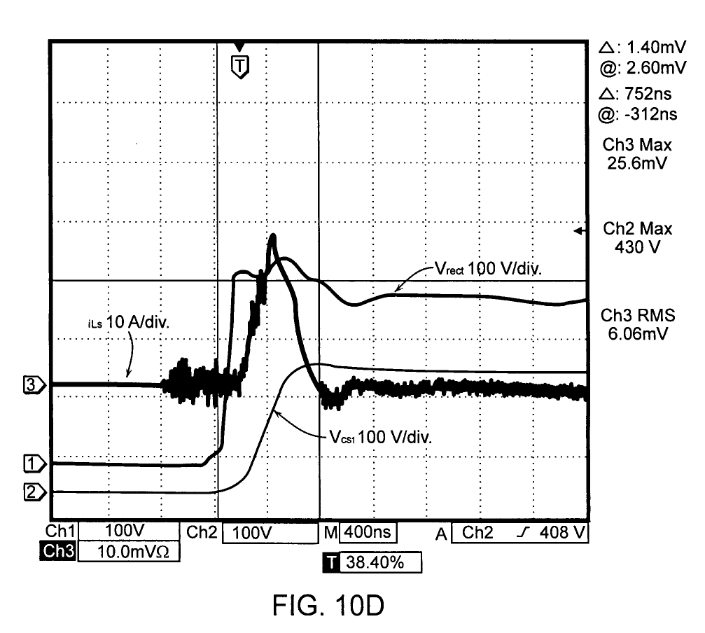

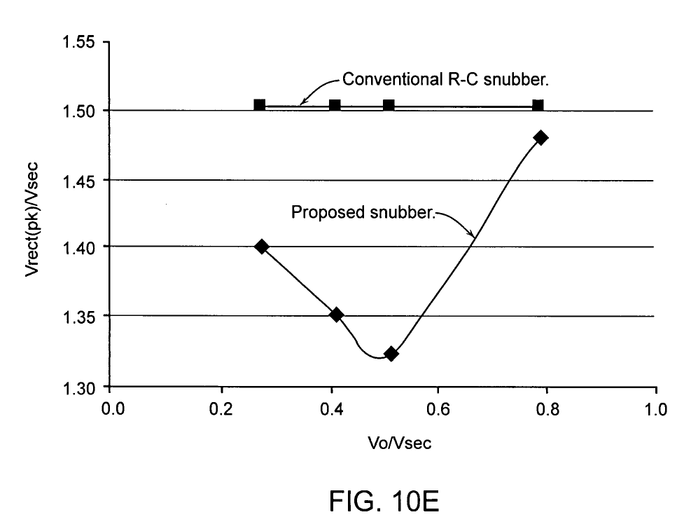

FIG. 10A is a diagram that shows the signal waveforms observed during operation of the power supply unit of FIG. 9. Specifically, FIG. 10A shows the output rectifier voltage stress (vrect), the snubber current i_{Ls} and the voltage across the auxiliary snubber capacitor Cₛ₁ (V_{cs1}) during the energy delivery period. By utilizing the snubber circuit of FIG. 9, the peak output rectifier voltage stress (vrect (pk)) is observed to be reach about 392 V, while the snubber power dissipation in resister Rs is around 45 W.

In contrast, a comparative evaluation of the conventional R-C snubber circuit of FIG. 1 can be conducted by disconnecting the auxiliary snubber circuit and performing measurements under the same test conditions with the following R-C snubber values: Rₛ=3.75 ohms/200 W and Cₛ=0.033 μf/1600V. FIG. 10B is a diagram that shows the signal waveforms observed during operation of the power supply of FIG. 9 retrofitted with a conventional R-C snubber circuit. As shown in FIG. 10B, the peak output rectifier voltage stress (vrect(pk)) is observed to increase to 434V under these conditions while the snubber power dissipation in resister Rs is 135 W. Thus the snubber circuit of FIG. 9 achieves a significant reduction in the snubber power dissipation while reducing the peak overshoot of output rectifier voltage v_{rect} when compared to the conventional R-C snubber circuit under the same test conditions.

Further evaluation of the power supply unit of FIG. 9 has been conducted with Vo varied over a wide range from 80 V-260 V. For example, FIGS. 10C and 10D are diagrams that show the signal waveforms observed during operation of the power supply unit of FIG. 9 with output voltage Vo at 150 V and 230 V respectively. Further results from this experiment are summarized in Table 4.

TABLE 4

| Rload (Ω) | vrect (pk) (V) | Vo (V) | Io (A) | iLs(pk) (A) |
|---|---|---|---|---|
| 7 | 440 | 260 | 37 | 19.8 |
| 4.7 | 452 | 260 | 55 | 21 |
| 3.5 | 436 | 260 | 75 | 21.2 |
| 2.3 | 430 | 230 | 100 | 25.6 |
| 1.5 | 384 | 150 | 100 | 30 |
| 1.2 | 392 | 120 | 100 | 33 |
| 0.8 | 406 | 80 | 100 | 32.6 |

These results generally covers the typical plasma arc load voltage range, which generally lies between 100 V-200 V. Vo is limited to around 260 V since the maximum PWM duty cycle of operation is preferably limited to 92%. Also, load current Io is typically lower than its rated value of 100 A for Vo greater than 230 V due to lack of availability of suitable load resistor values at these voltages. FIG. 10E displays the variations in the normalized rectifier voltage with the power supply normalized output voltage due to the new and conventional snubber circuits at a rated load. As shown, FIG. 10E illustrates that the stress due to the new snubber circuit is lower than that due to the conventional R-C snubber circuit while at the same time consuming 60% less power.

Based on these experimental results, the following remarks can be made to particular embodiments of the snubber circuit:

(1) vrect peak overshoot value can be reduced by 30% while the snubber power dissipation is reduced by 60% at nominal load, i.e. 100 A, 180 V when compared with the conventional R-C snubber of FIG. 1.

(2) Table 4 shows an increase in vrect (pk), especially for Vo higher than 180 V since the auxiliary circuit diverts less reverse recovery current Irr. A larger portion of the reverse recovery current Irr flows into the Rs-Cs branch increasing the output rectifier voltage stress (vrect) in the process. However, the stress level is still less than that obtained with the conventional R-C snubber of FIG. 1 for Vo less than 230 V.

(3) Although at lower current levels, operation at Vo greater than 230 V can result in the output rectifier voltage stress (vrect) exceeding the levels obtained with the conventional R-C snubber. However, the stress levels are still reasonable enough to permit use of 600 V rating diodes for this application. Besides, these levels are usually outside the normal load operating range.

(4) Referring to Table 4 and FIG. 10E, a similar increase in the peak output rectifier voltage stress (vrect (pk)) can be expected for Vo less than 80 V. This is because now there is greater current build-up in the snubber inductor Ls of the auxiliary circuit during the Dfw reverse recovery period with lower Vo. This can result in a greater voltage observed being observed across snubber capacitor (Cs1) and hence a greater peak output rectifier voltage stress (vrect (pk)) during the subsequent resonant period when energy is transferred from snubber inductor Ls to the snubber capacitor Cs1 of the non-dissipative auxiliary snubber circuit.

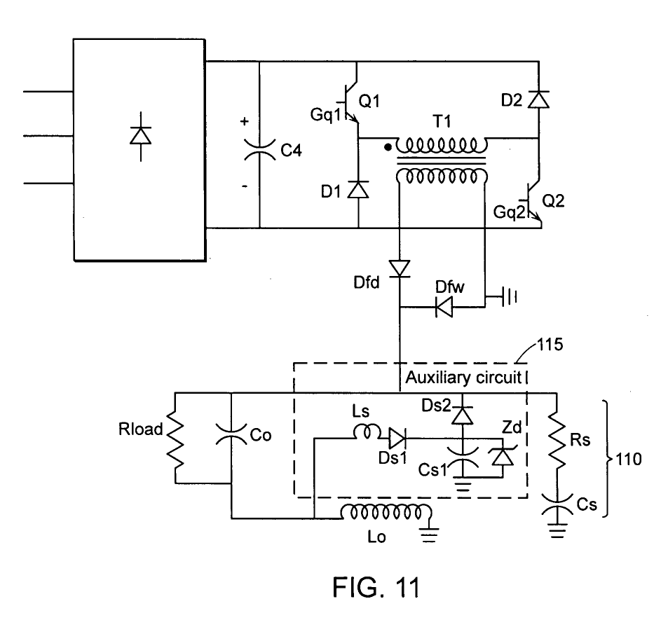

FIG. 11 is a schematic circuit diagram of a two-switch forward converter power supply including a snubber circuit according to a second embodiment. In this embodiment, the snubber circuit is similar to the snubber circuit of FIG. 2, except that a zener diode Zd is coupled in parallel to snubber capacitor Cs1. The function of the zener diode is to clamp the voltage across the snubber capacitor Cs1 and thereby limit the maximum rectifier voltage stress. This enables further reduction in the power rating of the snubber resister Rsnub, because the zener diode now provides an alternate means for dissipating power.

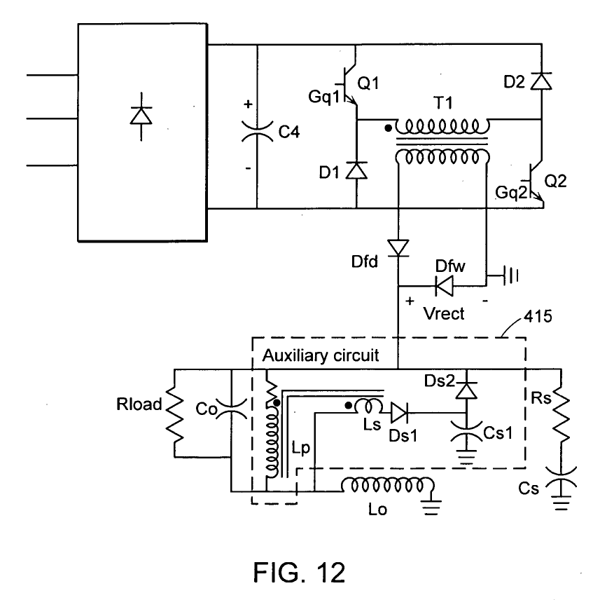

FIG. 12 is a schematic circuit diagram of a two-switch forward converter power supply including a snubber circuit according to a third embodiment. In this embodiment, the snubber circuit is similar to the snubber circuit of FIG. 2, except that the resonant auxiliary snubber circuit 415 includes an additional winding Lp that is coupled to the resonant inductor Ls. Simulations have shown that reducing the resonant inductor value Ls with increase in output voltage Vₒ helps to reduce the variation in peak output rectifier voltage stress (V_{rect}(pk)) due to changes in Vₒ. Here, the value of inductor Ls is determined by the current flowing through its additional winding Lp and Vo. This current saturates the inductor core at high Vo and reduces its value in the process. Table 5 contains a summary of the simulation results with inductor Ls replaced by an inductor whose value varies in the ratio 3:1 over the entire output voltage range. The results show a reduction in output rectifier voltage stress (vrect(pk)) at low and high Vo as compared to the snubber circuit of FIG. 2.

TABLE 5

| Vo (V) | Vi (V) | vrect (pk) − V | Ls (μh) | vrect (pk)/Vi |
|---|---|---|---|---|
| 0 | 350 | 507 | 12 | 1.45 |
| 150 | 350 | 470 | 8 | 1.34 |
| 350 | 350 | 492 | 4 | 1.40 |

While this invention has been particularly shown and described with references to preferred embodiments thereof, it will be understood by those skilled in the art that various changes in form and details may be made therein without departing from the scope of the invention encompassed by the appended claims.

What is claimed:

1. A snubber circuit for absorbing reverse recovery current in a power supply, comprising:
a dissipative snubber circuit and a non-dissipative snubber circuit coupled in parallel to a source of reverse recovery current and a load;
the dissipative snubber circuit dissipating a first amount of reverse recovery current from the reverse recovery current source; and
the non-dissipative snubber circuit recovering a second amount of reverse recovery current from the reverse recovery current source, resulting in the reverse recovery current being absorbed with reduced power dissipation.

2. The snubber circuit of claim 1 wherein the dissipative snubber circuit comprises:
a snubber resister coupled in series to a snubber capacitor, the snubber resister having a resistance value sufficient to dissipate the first amount of reverse recovery current from the reverse recovery current source, the first amount of reverse recovery current being less than the total amount of reverse recovery current.

3. The snubber circuit of claim 2 wherein the snubber resistor has a power rating for dissipating the first amount of reverse recovery current being less than a power rating sufficient for dissipating the total amount of reverse recovery current.

4. The snubber circuit of claim 1 wherein the non-dissipative snubber circuit comprises:
a resonant circuit including a resonant inductor; and
a resonant capacitor having a capacitance sufficient to limit a voltage spike across the reverse recovery current source.

5. The snubber circuit of claim 4 wherein the non-dissipative snubber circuit further comprises:
a zenor diode coupled in parallel across the resonant capacitor to further limit the voltage spike across the reverse recovery current source.

6. The snubber circuit of claim 4 wherein the non-dissipative snubber circuit further comprises:
a winding being coupled in parallel to the load, the winding being magnetically coupled to the resonant inductor, resulting in variations in the voltage spike being reduced in response to changes in an output voltage across the load.

7. The snubber circuit of claim 1 wherein the source of reverse recovery current comprises:
a diode rectifier circuit coupled in parallel between a transformer and the load, the transformer storing reverse recovery current from the diode rectifier circuit.

8. The snubber circuit of claim 7 wherein the diode rectifier circuit further comprises:
a forward diode and a freewheeling diode, the forward diode being coupled in series to the transformer, the freewheeling diode being coupled in parallel to the series-coupled transformer and forward diode;
the non-dissipative snubber circuit comprising a resonant circuit, the resonant circuit including a resonant inductor and a resonant capacitor, the resonant capacitor having a capacitance sufficient to limit a voltage spike across the freewheeling diode.

9. The snubber circuit of claim 1 wherein the power supply is a power supply for a high temperature metal processing torch.

10. A method of absorbing reverse recovery current in a power supply, the power supply comprising a dissipative snubber circuit and a non-dissipative snubber circuit coupled in parallel to a source of reverse recovery current and a load, the method further comprising:
dissipating a first amount of reverse recovery current from the reverse recovery current source through the dissipative snubber circuit; and
recovering a second amount of reverse recovery current from the reverse recovery current source through the non-dissipative snubber circuit, resulting in the reverse recovery current being absorbed with reduced power dissipation.

11. The method of claim 10 wherein the dissipative snubber circuit comprises a snubber resister coupled in series to a snubber capacitor, the method further comprising:
dissipating the first amount of reverse recovery current from the reverse recovery current source through the snubber resister, the snubber resister having a resistance value sufficient to dissipate an amount of reverse recovery current which is less than the total amount of reverse recovery current.

12. The method of claim 10 wherein the dissipative snubber circuit comprises a snubber resister coupled in series to a snubber capacitor, the method further comprising:
dissipating the first amount of reverse recovery current from the reverse recovery current source through the snubber resister, the snubber resister having a power rating for dissipating an amount of reverse recovery current which is less than a power rating sufficient for dissipating the total amount of reverse recovery current.

13. The method of claim 10 wherein the non-dissipative snubber circuit comprises a resonant circuit that includes a resonant inductor and a resonant capacitor, the method further comprising:
recovering the second amount of reverse recovery current from the reverse recovery current source through the non-dissipative snubber circuit, the resonant capacitor having a capacitance sufficient to limit a voltage spike across the reverse recovery current source.

14. The method of claim 10 wherein the source of reverse recovery current comprises a diode rectifier circuit coupled in parallel between a transformer and the load, the transformer storing reverse recovery current from the diode rectifier circuit.

15. The method of claim 14 wherein the non-dissipative snubber circuit comprises a resonant circuit that includes a resonant inductor and a resonant capacitor, the method further comprising:
recovering the second amount of reverse recovery current from the transformer through the non-dissipative snubber circuit, the resonant capacitor having a capacitance sufficient to limit a voltage spike across the diode rectifier circuit.

16. The method of claim 15 wherein the non-dissipative snubber circuit further comprises a zenor diode coupled in parallel across the resonant capacitor to further limit the voltage spike across the reverse recovery current source.

17. The method of claim 15 wherein the non-dissipative snubber circuit further comprises a winding being coupled in parallel to the load, the winding being magnetically coupled to the resonant inductor, resulting in variations in the voltage spike being reduced in response to changes in an output voltage across the load.

18. A method of manufacturing a snubber circuit that absorbs reverse recovery current in a power supply, comprising:
coupling a dissipative snubber circuit and a non-dissipative snubber circuit in parallel to a source of reverse recovery current and a load;
wherein the dissipative snubber circuit is capable of dissipating a first amount of reverse recovery current from the reverse recovery current source through the dissipative snubber circuit and the non-dissipative snubber circuit is capable of recovering a second amount of reverse recovery current from the reverse recovery current source through the non-dissipative snubber circuit, resulting in the reverse recovery current being absorbed with reduced power dissipation.

19. The method of claim 18 further comprising:
providing the dissipative snubber circuit comprising a snubber resister coupled in series to a snubber capacitor, the snubber resister having a resistance value sufficient to dissipate an amount of reverse recovery current from the reverse recovery current source which is less than the total amount of reverse recovery current.

20. The method of claim 18 further comprising:
providing the dissipative snubber circuit comprising a snubber resister coupled in series to a snubber capacitor, the snubber resistor having a power rating for dissipating an amount of reverse recovery current which is less than a power rating sufficient for dissipating the total amount of reverse recovery current.

21. The method of claim 18 further comprising:
providing the non-dissipative snubber circuit comprising a resonant circuit, the resonant circuit including a resonant inductor and a resonant capacitor, the resonant capacitor having a capacitance sufficient to limit a voltage spike across the reverse recovery current source.

22. The method of claim 18 wherein the source of reverse recovery current comprises a diode rectifier circuit coupled in parallel between a transformer and the load, the transformer storing reverse recovery current from the diode rectifier circuit.

23. The method of claim 22 further comprising:
providing the non-dissipative snubber circuit comprising a resonant circuit, the resonant circuit including a resonant inductor and a resonant capacitor, the resonant capacitor having a capacitance sufficient to limit a voltage spike across the diode rectifier circuit.

24. The method of claim 22 further comprising:
providing the diode rectifier circuit comprising a forward diode and a freewheeling diode, the forward diode being coupled in series to the transformer, the freewheeling diode being coupled in parallel to the series-coupled transformer and forward diode; and
providing the non-dissipative snubber circuit comprising a resonant circuit, the resonant circuit including a inductor, the resonant circuit further including a capacitor having a capacitance sufficient to limit a voltage spike across the freewheeling diode.

25. The method of claim 21 further comprising:
coupling a zenor diode in parallel across the resonant capacitor to further limit the voltage spike across the reverse recovery current source.

26. The method of claim 21 further comprising
coupling a winding in parallel to the load, the winding being magnetically coupled to the resonant inductor, resulting in variations in the voltage spike being reduced in response to changes in an output voltage across the load.

27. A snubber circuit for absorbing reverse recovery current in a power supply, the snubber circuit including a passive circuit for dissipating a first amount of reverse recovery current from the reverse recovery current source, the snubber circuit further comprising:
a non-dissipative snubber circuit coupled in parallel to a source of reverse recovery current and a load, the non-dissipative snubber circuit recovering a second amount of reverse recovery current from the reverse recovery current source, resulting in the reverse recovery current being absorbed with reduced power dissipation.

28. The snubber circuit of claim 27 wherein the non-dissipative snubber circuit includes a resonant circuit that recovers the second amount of reverse recovery current and maintains the voltage stress across a diode rectifier circuit within a rated range of the diode rectifier circuit.

29. A method of manufacturing a snubber circuit for absorbing reverse recovery current in a power supply, the snubber circuit comprising a dissipative snubber circuit coupled in parallel to a source of reverse recovery current and a load, the dissipative snubber circuit dissipating a first amount of reverse recovery current from the reverse recovery current source, the method comprising:
coupling to the snubber circuit a non-dissipative snubber circuit in parallel to the source of reverse recovery current and the load, the non-dissipative snubber circuit recovering a second amount of reverse recovery current from the reverse recovery current source, resulting in the reverse recovery current being absorbed with reduced power dissipation.

30. The method of claim 29 wherein the non-dissipative snubber circuit includes a resonant circuit that recovers the second amount of reverse recovery current and maintains the voltage stress across a diode rectifier circuit within a rated range of the diode rectifier circuit.

31. A power supply comprising:
a power source coupled to a transformer;
a diode rectifier circuit coupled in parallel between the transformer and a load, the transformer storing reverse recovery current from the diode rectifier circuit.
a snubber circuit for absorbing reverse recovery current in the power supply, the snubber circuit comprising a dissipative snubber circuit and a non-dissipative snubber circuit coupled in parallel to the transformer and the load;
the dissipative snubber circuit dissipating a first amount of reverse recovery current;
the non-dissipative snubber circuit recovering a second amount of reverse recovery current, resulting in the reverse recovery current being absorbed with reduced power dissipation.

32. The power supply of claim 31 wherein the non-dissipative snubber circuit includes a resonant circuit that recovers the second amount of reverse recovery current and maintains the voltage stress across the diode rectifier circuit within a rated range of the diode rectifier circuit.

33. A snubber circuit for absorbing reverse recovery current in a power supply, comprising:
means for dissipating a first amount of reverse recovery current from a source of reverse recovery current in a power supply; and
means for recovering a second amount of reverse recovery current in the power supply, resulting in the reverse recovery current being absorbed with reduced power dissipation.

34. The snubber circuit of claim 33 wherein means for recovering a second amount of reverse recovery current maintains the voltage stress across a diode rectifier circuit within a rated range of the diode rectifier circuit.
